(19) United States
(12) Patent Application Publication
(10) Pub. No.: US 2023/0343973 A1
(43) Pub. Date: Oct. 26, 2023

(54) SEALING ARRANGEMENT FOR ELECTROCHEMICAL CELLS OF THE PEM TYPE

(71) Applicant: Hoeller Electrolyzer GmbH, Wismar (DE)

(72) Inventor: Stefan HÖLLER, Lübeck (DE)

(21) Appl. No.: 17/768,678

(22) PCT Filed: Nov. 4, 2020
(86) PCT No.: PCT/EP2020/080901

§ 371 Date: Apr. 13, 2022

(30) Foreign Application Priority Data
Nov. 25, 2019 (WO) PCT/EP2019/082449

(51) Int. Cl. H01M 8/0276; H01M 8/0286; H01M 8/0282

(52) U.S. Cl. CPC H01M 8/0278; H01M 8/0286; H01M 8/0282; H01M 8/1004

(57) ABSTRACT

A sealing arrangement is provided for an electrochemical cell. The sealing arrangement includes a metallic plate (7) and a seal (18, 19) which is arranged thereon and which forms at least one closed sealing ring, which is arranged on the plate (7). A peripheral inner support structure (20, 22) supports the seal (18, 19) to the inside and an outer support structure (21, 23) supports the seal (18, 19) to the outside. The support structures are formed of sintered metal and are materially connected to the plate (7).

### CROSS REFERENCE TO RELATED APPLICATIONS

This application is a United States National Phase Application of International Application PCT/EP2020/080901, filed Nov. 4, 2020, and claims the benefit of priority of International Application PCT/EP2019/082449, filed Nov. 25, 2019, the entire contents of which are incorporated herein by reference.

### TECHNICAL FIELD

The present invention relates to an electrochemical cell, in particular to a stack of electrochemical cells, especially a sealing arrangement for electrochemical cells of the Proton Exchange Membranes (PEM) construction type, in particular for an electrolyzer.

### TECHNICAL BACKGROUND

Electrochemical cells of the aforementioned type are typically built into stacks, in which a multitude of such cells are connected in series and are arranged in a stack. Such stacks for example in the field of fuel cells are counted as belonging to the state of the art and serve for the generation of electricity by way of catalytic oxidation of hydrogen. Electrolyzers are also available in such a stack arrangement, with which electrolyzers hydrogen and oxygen are produced by way of bringing in electrical energy and water, of which typically one component, mostly hydrogen is intermediately stored. In order to design the production and storage as effectively as possible, one strives to design the stack such that it can be operated with a high as possible operating pressure of for example 100 bar, since then one can often make do without a post-compressing of the generated gas or this can be effected with a comparatively low energy effort. The higher the stress in the electrochemical cells the greater are the forces which act in the stack. Whereas the mechanical forces can be accommodated by way of a greater dimensioning of the strength of the end plates and tie-rods, the sealing of the cells becomes a greater problem with an increasing pressure. With an increasing pressure force, the seals are increasing loaded, but with a failure of a seal the complete stack becomes unusable.

### SUMMARY

The object of the invention to design a sealing arrangement for an electrochemical cell of the PEM construction type, in particular for an electrolyzer, such that the seal withstands as high as possible pressures.

According to the invention, this object is achieved by a sealing arrangement with the features as disclosed herein. Advantageous configurations of the invention are specified in the dependent claims, the subsequent description and the drawings.

The sealing arrangement according to the invention for an electrochemical cell of the PEM construction type, in particular for an electrolyzer comprises a metallic plate and a seal which is arranged thereon and which forms at least one closed sealing ring which is arranged on the plate. According to the invention, a peripheral inner support structure which supports the seal to the inside as well as an outer support structure which supports the seal to the outside is formed, and these are formed of sintered metal and are materially connected to the plate.

The basic concept of the solution according to the invention is to provide support structures to the inside as well as to the outside on the metallic plate which typically comprises media-permeable recesses in the middle which permeable to media and which there is typically formed by a perforated plate which for example amid the intermediate arrangement of a carbon non-woven as a gas diffusion layer lies on an ion-permeable, gas-tight membrane (PEM) membrane, said structures supporting the seal at both sides. These support structures according to the invention are formed from sintered metal and are materially connected to the plate. Preferably, the support structures are formed from the same metal as the plate and are materially connected to this, for example by way of sintering.

If the seal in the simplest form is a peripheral sealing ring which is arranged on the plate, then this is supported to the inside by a support structure which prevents the sealing material from moving inwards given subjection to force, and to the outside by an outer support structure which prevents the material from moving outwards. The seal is therefore preferably positively held between the support structures, so that the flow behavior which otherwise occurs given high surface pressing is effectively prevented. These support structures not only prevent a flowing of the seal but furthermore form a type of spacer which ensures a minimum distance between the metallic plate and the counter-surface which is to be sealed with respect to this.

Basically, an arrangement of the support structures to both sides of the seal, thus to the inside and outside is advantageous. However, in particular on operation of the electrochemical cell, in particular of a cell stack with a high inner pressure, as is advantageous with electrolyzers for the compressed storage of the reaction gases, it is sufficient to provide only one of the support structures, in particular advantageously an outer support structure, in order in this manner to form a barrier counter to the creep of the seal on account of the increased inner pressure to the outside.

According to an advantageous further development of the invention, seals are arranged at both sides of the plate and these on each side form at least one closed sealing ring which is arranged on the plate, wherein a peripheral inner structure which supports the respective seal to the inside and an outer support structure which supports the respective seal to the outside are formed on each side of the plate and are formed of sintered metal and are materially connected to the plate. Such an arrangement ensures that the seals are stabilized at both sides of the plates, the flow behavior of which given a high pressing pressure being prevented and furthermore a minimum distance to the counter-surface is ensured. In combination with respective counter-surface, the support structures with the plate and the counter-surface form a chamber-like space which receives the sealing ring which is arranged therein and limits the pressing-together, i.e. the compression of the sealing ring, to the volume of this space.

According to an advantageous embodiment of the invention, the plate itself is also formed from sintered metal and is preferably manufactured in the 3D printing method. Herein, preferably not only the plate itself but also the support structures can be manufactured in this method, preferably in one working procedure on pressing the plate.

Advantageously, the seal which forms the sealing ring is configured such that it preferably completely fills out the region between the inner and the outer support structure. Herein, it is particularly advantageous if the seal bears directly on the metallic plate at least in the region between the support structures. On account of the sealed bearing of the seal on the plate, on the one hand an adhesion of the seal on the plate is ensured and on the other hand a good and complete sealing effect. A possibly necessary bonding agent can be introduced in this region, without the danger existing of this bonding agent getting into regions outside the support structure and this into the active cell construction. These bonding agents damage or destroy the catalyzer on the membrane if they come into contact with this, which is why it is important that their region of application is locally limited in a reliable manner.

It is particularly advantageous if the seal preferably completely covers the support structures. Although one basically envisages the seal in the region between the support structures being configured significantly higher than the support structures, in order to ensure a sealing in this region, the covering of the support structures however has the advantageous of sealing material always being located between the upper side of the support structure and the counter-surface given maximal compression of the seal, and thus an additional sealing is ensured. Furthermore, the seal can be additionally fixed to the support material by way of the covering of the support structures by sealing material, by which means an intimate connection between the seal and the plate or the support structures which are arranged thereon is formed.

It is particularly favorable if a support structure is formed by a bead. Advantageously, herein it is an annularly peripheral bead which supports the seal in a complete peripheral manner. In the region of gas-leading channels, the bead and/or seal can be interrupted or have a lower height, without by way of this restricting the complete support of the seal over the complete peripheral region, since a support can be done away with in the region of such channels. Advantageously, the support structures are configured and arranged such that on the sides which face one another they are formed in a ramp-like manner and tapering at a distance to one another. This means that the inner structure, typically a bead has a region which tapers in an oblique and flat manner in the direction of the outer support structure and the outer structure has an obliquely and flatly tapering, thus ramp-like region towards the inner structure. The ramp-like sections herein taper at a distance to one another, so that the region which is formed therebetween is free of support structures, so that the seal here can bear directly on the metallic plate. At the sides which are away from the seal, the support structures can run out in a significantly steeper manner, as also above the ramp-like region, as will be clarified further below by way of an embodiment example.

This ramp-like tapering of the support structures is particularly advantageous, in order to achieve a complete as possible filling-out of the space which is delimited herewith, by sealing material and to ensure a good adhesive effect of the seal also in the region of the support structures.

In the simplest form, such a sealing ring which is arranged between an inner and an outer support structure can be configured in a plane manner at its side which is directed to the counter-surface, thus at the side which is away from the plate, and then this bears on the counter-surface in a surfaced manner. Such an extensive contact is advantageous for example for bearing on the ion-permeable membrane, since then the membrane is then subjected to the same force over the complete surface of the seal. In particular, at the other side of the plate it is however advantageous if the seal is not configured as a plane surface, but in a structured manner. Thus the seal can be advantageously provided with sealing lips at the side which is away from the plate, said sealing lips preferably being continuously peripheral over the entire seal. Herein, it is advantageous if a number of sealing lips is formed, said sealing lips quasi as concentric rings being provided on the side of the seal which is directed to the counter-surface, between the inner and the outer support structure. This side of the seal can also be configured in a wave-like manner in cross section at least at the outwardly directed side, and concentric contact surfaces in the region between the support structures also arise by way of this.

The seal which is arranged between the support structures on the plate and which forms a peripheral sealing ring is advantageously formed by injecting on the seal after the manufacture of support structures. Such a seal can be formed for example from FKM (fluorinated rubber) as is counted as belonging to the state of the art. The injecting-on is typically effected in the injection molding method, which is to say in a tool which forms the metallic plate with its support structures and the delimitations.

The metallic plate is advantageously formed by a foil section, thus a metallic sheet metal section. Separating the plate out of a foil is particular favorable and such foils are inexpensively available and by way of cutting can be brought into the desired dimensions of the later sheet metal section.

The support structures themselves are advantageously manufactured in the 3D printing method, and they are either deposited directly upon the plate or firstly onto a carrier foil which consists of plastic, wherein the support structures are connected to the plate by way of sintering. If these support structure are deposited onto the metallic plate by way of 3D printing, either a melting-on of the material is effected during the printing, thus the material connection directly on depositing or however a depositing of a metal powder with a binder which is removed given a later sintering, wherein the metal powder materially connects to one another and to the metal plate which is located therebelow.

The support structures can advantageously or alternatively be deposited in the screen-printing method, which in particular is inexpensive and productive in series manufacture. The connection of the support structures to the metal plate is then advantageously effected by way of sintering. Herein, the support structures can be deposited directly onto the metal plate by screen printing or a plastic foil be deposited as a carrier by way of screen printing.

If the support structures are deposited with the aid of a plastic foil as carrier, then the removal of the plastic foil is effected on sintering, concerning which the support structures are connected to the plate. It is to be understood that if support structures are provided at both sides, these are connected to the plate by way of sintering in a simultaneous manner or however in separate working procedures (firstly on the one side and then on the other side).

Advantageously, the support structure and the foil are manufactured in 3D printing in one working procedure, and herein the foil can be formed from the binding agent for the metallic part of the support structure or however from another plastic material which then advantageously not only forms the carrier, but the complete support structure and is not removed until sintering.

If the support structures are deposited on or in a plastic foil as carriers, then these are then laid upon the metallic plate and are connected to this by way of sintering. Herein, typically the support structures are deposited at one side of the plate in a plastic foil and then connected to the plate by way of sintering.

If the sealing arrangement is envisaged for an electrolyzer of the PEM construction type, then the metallic plate advantageously consists of titanium and has a thickness of 0.2 mm to 0.5 mm. If the seal arrangement is envisaged for a fuel cell, then the metallic plate advantageously consist of stainless steel and has a thickness between 0.1 mm and 0.2 mm

The support structure is advantageously formed from the same material as the metallic plate.

The support structure on the one hand should be configured as flatly as possible and as high as is necessary. Preferably, the support structure extends in a direction perpendicular to the plate by about 0.2 mm to 1.2 mm

The cross-sectional shape of the support structure can vary and typically two beads are arranged at a distance to one another on the plate at one side, between which a seal is formed. These beads can comprise a semicircular, trapezoidal or other cross section and the bead width is advantageously between 0.2 mm to 2.0 mm.

As is specified further above, it is advantageous if the support structure apart from the actual bead comprises a part which tapers in a ramp-like manner and which advantageously has a width of 0.5 mm to 7 mm and is configured considerably more flatly than the actual bead. Herein the parts which run out in a ramp-like manner are arranged such that they have a certain distance to one another, so that the seal bears directly on the metallic plate in the region therebetween. The average bead distance which is to say the distance of the longitudinal middle lines of the beads which form the actual support structure, is advantageously between 1.5 mm and 15 mm. The average distance in the context of the invention is to be understood as the distance of the longitudinal middles to one another, as is represented in FIG. 3 further below.

The aforementioned dimensions in particular are advantageous for cell arrangements in stacks of for example 5 to 250 cells which are operated at a pressure of up to approx. 100 bar as electrolysis cells.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a plan view of a sealing arrangement according to the invention;

FIG. 2 is an enlarged schematic representation, a section through an electrolysis cell of a cell stack; and

FIG. 3 is an enlarged schematic sectioned representation, the metallic plate in the region of the seals and support structures.

### DESCRIPTION OF PREFERRED EMBODIMENTS

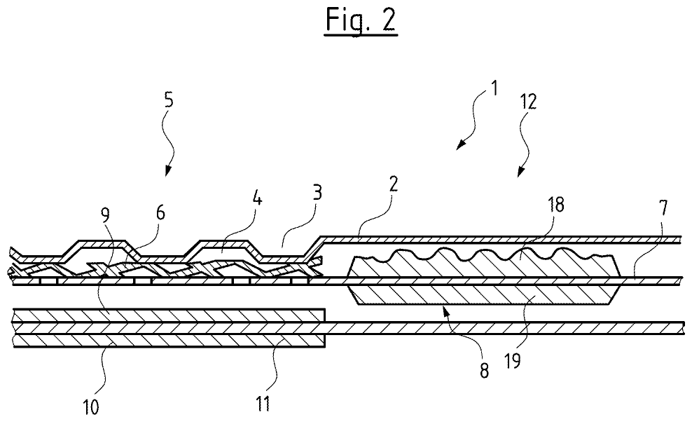

Referring to the drawings, the seal arrangement which is represented by way of the figures is part of an electrochemical cell whose construction is represented schematically in FIG. 2. The subsequently described embodiment relates to a sealing arrangement for an electrolysis cell for generating hydrogen and oxygen from water amid the application of electrical energy. It is to be understood that given the application of other media or given a reversal of the process (fuel cell), the basic construction of the electrochemical cell is unchanged, but various modifications be they concerning the applied materials or their arrangement are necessary.

Such electrochemical cells are constructed into cell stacks, so-called stacks, in which a multitude of such cells are typically connected electrically in series and are arranged lying on one another, wherein the cell stack is held mechanically by way of tie elements and channels for feeding and discharge media are provided within the cell stacks. These channels pass through the stack in a perpendicular manner, in order to connect each individual cell to the respective media feed and discharge. The basic construction of such cell stacks is counted as belonging to the state of the art and is therefore not described in any detail. In this context, however in particular for example DE 10 2017 108 413 A1 is referred to, wherein such a construction is described in detail.

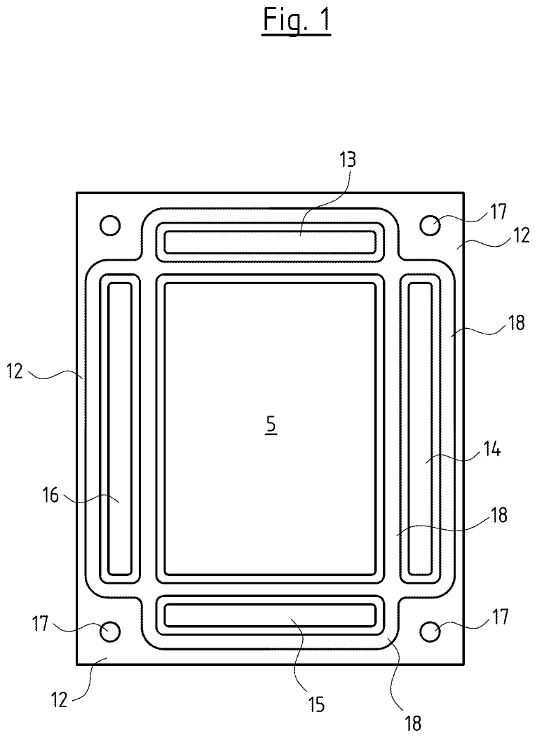

Each cell 1, as is illustrated in the sectioned representation according to FIG. 2, comprises a bipolar plate 2 which forms channels to both sides. Thus channels 3 are formed on the upper side which is represented in FIG. 2 and channels 4 on the lower side. The upper side is the side which leads water and oxygen on operation, wherein the lower side forms the hydrogen-leading side. A resilient element 6 which is formed by an expanded metal but can also be configured in another manner connects onto the bipolar plate 2 in the active region of the cell 1 which is characterized at 5 in FIG. 1.

This resilient element 6 which in FIG. 2 bears with its upper side on the bipolar plate 2, at the lower side bears on a plate 7 which is part of the sealing arrangement 8. This plate 7 in the active region 5 of the cell 1, this in the middle region 5 is configured as a perforated plate and the actual sealing arrangement 8 is formed in the edge region. This plate 7 bears on a media-permeable layer 9 which is denoted as a porous transport layer (PTL), in the active region 5. This gas-permeable layer lies in front of a proton-permeable membrane 10 which in the active region 5 of the cell 1 is also provided with such a media-permeable layer 11 at the rear side. The membrane 10 in a manner known per se is coated with electrodes at both sides, said electrodes acting as catalyzer. In turn, a bipolar plate 2 which is not shown in FIG. 2 and which forms part of the electrolysis cell which connects thereto connects at the bottom onto this media-permeable layer 11. The construction of the cell is such that the media are fed and discharged through the channels 3 and 4 and can come onto the membrane 10 is a surfaced manner, and specifically in the active region 5 of the cell 1

The components 6, 7, 9 and 11 however not only need to be media-permeable, in order to be able to lead the reactants onto the membrane 10 or away from this, they must also be able to electrically conduct, in order to feed the current which is necessary for the reaction. The contacting is effected in each case via a bipolar plate 2. In the represented embodiment therefore the bipolar plate 2, the resilient element 6, the plate 7 and media-permeable layer 11 are formed from titanium, and specifically the bipolar plate 2 by way of an embossed sheet, the resilient element 6 by way of a sheet which is configured in the manner of an expanded metal, the plate 7 by a titanium foil and the media-permeable layer 11 by a knitted fabric, similar to a felt, which is manufactured from titanium fibers. The media-permeable layer 9 is formed from a carbon non-woven.

As is evident from FIG. 1, the active region 5 of the cell 1 is to be differentiated from the edge 12 which is used for the channel formation and for fastening the cells amongst one another. Channels 13, 14, 15 and 16 via which the media feed and discharge is effected and which run perpendicularly through the stack of cells are formed in this edge 12. Furthermore, recesses 17 are formed in the corner regions and are provided for leading through clamping bolts, with which the cell stack is pressed together and held. Further recesses for tie rods can be provided in the edge region.

As FIG. 1 illustrates, the sealing arrangement 8 is peripheral in the edge 12, thus is configured as a closed ring. This closed ring surrounds the channels 13 to 16 to the outside. Furthermore, this sealing arrangement comprises rings which are closed per se and which surround the channels 13 to 16 and surround the active region 5. In sections, the last ring is reduced in height, in order to connect the channels 3 of the respective cell 1 to the channels 14 and 16 which run perpendicularly in the stack. The supply with water as well as the discharge of the arising oxygen is effected via the channels 14 and 16.

The connection of the hydrogen-side space which amongst other things is formed by the channels 4 and free spaces in the resilient element 6 is effected by way of the seal 18 being sunk in the regions which are adjacent to the channels 13 and 15, in order to create a channel connection for the discharge of the hydrogen here. The peripheral seals 18 and 19 which surround the channels 13 to 16 to the outside in contrast are configured in a continuously bearing manner and seal the respective cell to the outside.

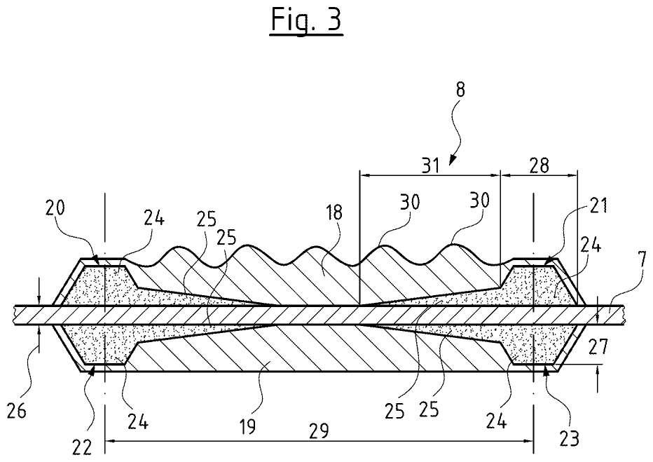

This sealing arrangement 8 as FIGS. 2 and 3 shows comprises a seal 18 which is at the top in the figures and which seals with respect to the bipolar plate 2 and a lower seal 19 which seals with respect to the membrane 10. These seals 18, 19 consist of fluorinated rubber and are injected on.

The seal 18 on the upper side of the plate 7, towards the inside, thus to the channels 13 to 16 is surrounded by a peripheral inner support structure 20 and to the outside by an outer support structure 21. The seal 19 on the lower side accordingly comprises an inner support structure 22 and an outer support structure 23. Each support structure (20-23) consist of a peripheral bead 24 and a region 25 which tapers in a ramp-like manner and in a manner connecting laterally into the region below the seal 18 and 19 respectively. The ramp-shaped region 25 of each support structure starting from the bead 24 extends at roughly half the height up to the plate 7 in a manner tapering to the opposite bead 25. A free space in which the seal 18 and 19 respectively bears directly on the plate 7 is formed between the tapering regions 25.

The plate 7 which with regard to the represented embodiment consists of a titanium foil has a thickness 26 of 0.3 mm. The support structures 20 to 23 which extent at both sides of the plates each comprise a peripheral bead 24 which has an extension 27 perpendicular to the plate 7 of 0.6 mm. The width 28 of a bead 24 with the represented embodiment is 1 mm, the width 31 of the part 25 which tapers in a ramp-like manner 1.5 mm. The average distance 29 of the beads 24 of the inner structure 20 and 22 respectively and of the outer structure 21 and 23 respectively is 8 mm.

Concerning the represented embodiment, the plate 7 is formed from a titanium foil which is configured in a perforated manner in the active region 5, in order to be media-permeable. The support structures 20 and 21 at the upper side and 22 and 23 at the lower side are created with 3D printing and likewise consist of titanium. The connection amongst one another and to the plate 7 is formed by sintering. Herein, the manufacture can be different, as has been initially specified.

After the plate 7 is formed with the support structures 20 to 23 which are located thereon, the upper seal 18 and the lower seal 19 are manufactured with the injection molding method. Herein, the seals bear directly on the plate 7 in the region between the tapering, ramp-like regions 25. With regard to the present embodiment variant, the seals completely cover the beads. 24. Whereas the lower seal 19 has a plane lower side as a sealing side which has a small distance to the beads 24 of the support structure 22 and 23 respectively, the upper seal 18 comprises an upper side which is wave-like in cross section, thus sealing side, wherein the wave troughs lie at roughly the height of the upper side of the seal in the region of the beads 24 and form the sealing lips 30 which run around the wave peak 30 and which are significantly elevated with respect to these.

While specific embodiments of the invention have been shown and described in detail to illustrate the application of the principles of the invention, it will be understood that the invention may be embodied otherwise without departing from such principles.

### LIST OF REFERENCE NUMERALS

1 cell
2 bipolar plate
3 channels
4 channels
5 active region of the cell
6 resilient element
7 plate
8 sealing arrangement
9 media-permeable layer
10 membrane
11 media-permeable layer
12 edge of the plate 7
13 perpendicular channels
14 perpendicular channels
15 perpendicular channels
16 perpendicular channels
17 recesses
18 seal top
19 seal bottom
20 inner support structure top
21 outer support structure top
22 inner support structure bottom
23 outer support structure bottom
24 bead
25 region tapering in a ramp-like manner
26 thickness of the plate 7
27 height of the bead 24
28 width of the bead 24
29 average bead distance
30 sealing lips
31 width of the region which tapers in a ramp-like manner

1. A sealing arrangement for an electrochemical cell of a proton exchange membrane (PEM) construction the sealing arrangement comprising
a metallic plate; and
a seal arranged on the plate and which forms at least one closed sealing ring which is arranged on the plate,
a support structure formed of sintered metal and materially connected to the plate, the support structure comprising at least one of:
a peripheral inner support structure which supports the seal to an inside and
an outer support structure which supports the seal to an outside.

2. A sealing arrangement according to claim 1, further comprising another seal, wherein the seals are arranged at both sides of the plate and on each side form at least one closed sealing ring which is arranged on the plate, wherein the peripheral inner support structure which supports the respective seal to the inside and the outer support structure which supports the respective seal to the outside is formed on each side of the plate.

3. A sealing arrangement according to claim 1, wherein the plate is comprised of sintered metal and is manufactured in a 3D printing method.

4. A sealing arrangement according to claim 1, wherein the seal fills out a region between the inner support structure and the outer support structure and bears directly on the plate at least in the region between the support structures.

5. A sealing arrangement according to claim 1, wherein the seal covers the support structure.

6. A sealing arrangement according claim 1, wherein the support structure comprises an annularly peripheral bead.

7. A sealing arrangement according to claim 6, wherein the support structure and/or the seal in regions in which channels are formed are configured to be flatter than in other regions or is interrupted.

8. A sealing arrangement according to claim 1, wherein the support structures on sides which face one another are formed tapering, with a ramp shape, at a distance to one another.

9. A sealing arrangement according to claim 1 further comprising another seal, wherein the seals are arranged at both sides of the plate wherein the seal at a side which is away from the plate has a plane form and/or the other seal at a side which is away from the plate comprise sealing lips.

10. A sealing arrangement according to claim 1, wherein the seal is formed by way of injecting on after the manufacture of the associated support structures.

11. A sealing arrangement according to claim 1, wherein the plate is formed by a foil section.

12. A sealing arrangement according to claim 1, wherein the support structures are manufactured with a 3D printing method.

13. A sealing arrangement according to claim 1, wherein the support structures are deposited onto the plate in a screen printing method.

14. A sealing arrangement according to claim 1, wherein the support structures are formed by way of sintering.

15. A sealing arrangement according to claim 1, wherein the support structures are connected to the plate by way of sintering.

16. A sealing arrangement according to claim 1, wherein the support structure is deposited onto or brought into a plastic foil as a carrier, wherein the plastic foil is arranged on the plate and is removed upon sintering.

17. A sealing arrangement according to claim 1, wherein the plate is comprised of titanium and has a thickness of 0.2 to 0.5 mm.

18. A sealing arrangement according to claim 1, wherein the plate is comprised of stainless steel and has a thickness of 0.1 to 0.2 mm.

19. A sealing arrangement according to claim 1, wherein the support structure has an extension perpendicular to the plate of 0.2 to 1.2 mm.

20. A sealing arrangement according to claim 1, wherein the support structure is configured as a bead with a bead width of 0.2 to 2.0 mm.

21. A sealing arrangement according to claim 8, the part of the support structure which tapers with a ramp shape has a width of 0.5 to 7 mm.

22. A sealing arrangement according to claim 1, wherein the support structures have an average bead distance of 1.5 to 15 mm.
